(19) United States
(12) Patent Application Publication
(10) Pub. No.: US 2007/0288229 A1
(43) Pub. Date: Dec. 13, 2007

(54) Automated word processor for Chinese style languages

(76) Inventor: Chang Po Liu, Rancho Polas Verdes, CA (US)

Correspondence Address: Raymond Y. Chan, Suite 128, 108 N. Ynez Ave., Monterey Park, CA, 91754, US

(21) Appl. No.: 11/893,666

(22) Filed: Aug. 16, 2007

Related U.S. Application Data
(63) Continuation-in-part of application No. 09/832,153, filed on Apr. 10, 2001.

(51) Int. Cl. G06F 17/20

(52) U.S. Cl. 704/8

(57) ABSTRACT

A process for inputting word character includes the step of inputting a specific character denoting a nature art of destining word character; inputting a phonetic character denoting a phoneme of the destining word character; sorting out the destining word character in responsive to the specific character and the phonetic character; and outputting the destining word character. Therefore, the user is able to only refine the natural art and the pronounce of the word character in order to accurately input the destining word character.

### CROSS REFERENCE OF RELATED APPLICATION

This is a CIP application of a non-provisional application having an application Ser. No. 09/832,153, and a filing date of Apr. 10, 2001.

### BACKGROUND OF THE PRESENT INVENTION

1. Field of Invention

The present invention relates generally to an improved design of word and data processing device for typing Chinese words, and more particularly to combine specific and phonetic character instillation method to improve the accuracy of Chinese typing especially for people who is not Chinese native speaker and can only pronounce the Chinese word approximately.

2. Description of Related Arts

Nowadays, computers become one of the major communication tools to send and receive messages among people. Generally speaking, computer keyboard is the most common inputting device for inputting words for computer. There are many different kinds of the existing keyboard being used around the world. However, the only English installation to the Internet user, for the most part, doesn't correspond with the actual needs. People coming from all over the world speak at least two different languages in their work or lives. In order to meet the needed of typing, more and more different language instillation software accompanying with keyboards are developed by the inventors. It increases not only in typing speed, but also in its accuracy.

Two types of word input methods for the Chinese-style languages have been used. The first method is to select individually each word from a memory reservoir of the Chinese-style vocabulary and to plant it at the intended location in the sequence of a sentence. The second method is to write phonetically each Chinese-style word in Latin or English alphabets. A word-input method also uses the combination of these two methods.

The efficiencies of these devices are minimal. The first method is essentially the age-old manual word-input machine. The second method cannot be used effectively because of the massive numbers of words in the Chinese-style languages that sounds phonetically too close to be distinguishable from one another. Second, others applied in selecting individually each word from a memory reservoir of the Chinese-style vocabulary and to plant it at the intended location in the sequence of a sentence is highly recommended by great language ability user. It is too hard for people to use when people is not so familiar with the language. So it still has many improvements we can do for the key panels.

### SUMMARY OF THE PRESENT INVENTION

The main object of this invention is to provide means of high speed automated processing for words of Chinese-style languages. A new type of data processing terminal devices can be constructed based on this invention. Each of the new terminals has a set of new typing letter keys in addition to the traditional alphabets to produce the specific lettering symbols in Chinese for classification of actual Chinese words. The Chinese-type words are to be produced phonetically with alphabets together with these new Chinese symbols. The purpose of these new symbols is to differentiate the large number of phonetically similar words in the Chinese-style languages. These selected symbols are the most distinctive ones that Chinese people are generally very familiar with.

Another object of the present invention is to provide a process and system for inputting word character, wherein the process combine a specific and phonetic denoting could be improve the accuracy of installing the Chinese word especially benefit for people who is not Chinese native speaker and can only pronounce the Chinese word approximately.

Another object of the present invention is to provide a process and system for inputting word character that is low cost for high speed word and data processing.

Another object of the present invention is to provide a process and system for inputting word character wherein the input device can widely use in different fields such as PDA, phones, and etc.

Another object of the present invention is to provide a process and system for inputting word character wherein the specific character denoting a nature art is very practical and is easy to learn such that the user can pick up this method very quickly.

In order to accomplish the above objects, the present invention provides a process for inputting word character, comprising the step of:

(a) inputting a specific character denoting a nature art of destining word character;

(b) inputting a phonetic character denoting a phoneme of the destining word character;

(c) sorting out the destining word character in responsive to the specific character and the phonetic character; and

(d) outputting the destining word character.

The present invention also provides an input device for inputting word character, comprising:

a key panel comprising a plurality of function keys and a plurality of alphabetical letter keys from A to Z, wherein the function keys are used to input a specific character by a combination of the function keys, wherein the alphabetical letter keys are used to input a phonetic character by a combination of the alphabetical letter keys; and

a word processing unit, comprising:

a nature art character database containing a plurality of nature art groups, wherein each of the nature art groups contains a plurality of word characters classified with a common nature art;

a phonetic character database containing a plurality of phonetic groups, wherein each of the phonetic groups contains the word characters classified with a common phoneme; and

a word processor sorting out a common character from the nature art character database and the phonetic character database in responsive to the specific character and the phonetic character, wherein the common character is a destining word character.

The present invention further provides and input device for inputting word character, comprising:

a key panel comprising a plurality of function keys and a plurality of alphabetical letter keys from A to Z, wherein said function keys are used to input a specific character by a combination of said function keys, wherein said alphabetical letter keys are used to input a phonetic character by a combination of said alphabetical letter keys; and

a word processing unit, comprising:

a nature art character database containing a plurality of nature art groups, wherein each of said nature art groups contains a plurality of word characters classified with a common nature art;

a phonetic character database containing a plurality of phonetic groups, wherein each of said phonetic groups contains said word characters classified with a common phoneme; and

a word processor sorting out a common character from said nature art character database and said phonetic character database in responsive to said specific character and said phonetic character, wherein said common character is a destining word character.

These and other objectives, features, and advantages of the present invention will become apparent from the following detailed description, the accompanying drawings, and the appended claims.

### BRIEF DESCRIPTION OF THE DRAWINGS

FIG. 1 illustrates a schematic of the improved information processing system for transmitting data that involving Chinese-style language words.

FIG. 2 illustrates a schematic arrangement of the Chinese character keys on the improvement input keyboard.

FIG. 3 is a flow diagram illustrating a process for inputting data according to the preferred embodiment of the present invention.

FIG. 4 is a block diagram illustrating the word processing system according to the preferred embodiment of the present invention.

FIG. 5 illustrates the input device of the word processing system according to the preferred embodiment of the present invention.

FIG. 6 illustrates an alternative mode of the input device of the word processing system according to the preferred embodiment of the present invention.

### DETAILED DESCRIPTION OF THE PREFERRED EMBODIMENT

“Language” is defined in Webster's Dictionary in many ways, one way it is defined as: “any means of expressing or communicating, as gestures, signs, animal sounds, etc.”

Indo-European languages are essentially based on phonetics with multiple syllables; their spoken and written words differ little except in cases where the written words have silent alphabets.

Chinese style languages which include mainly Chinese, and its derivatives of Japanese and Korean languages, are not strict phonetic languages. Written words of these languages dictate over the phonetic expressions. Which means all contracts must be in writing. These facts are known to every student of China, Japan and Korea. Chinese style languages have large number of words in identical sound, while their written words are distinctive from one another. Homonyms in Chinese written words are very rare, as compared to the hundreds of homonyms occurring in every day English written and spoken words.

When one talks about Chinese written words, the facts of the following paragraphs are intrinsically embodied within this language. It does not need extended explanation. The facts are reiterated here for clarification purpose regarding this patent application only.

Foundation of Chinese written words started as pictures and then they were simplified into meaningful multi-stroke symbols. Most Chinese style written words have the whole calligraphy or a part of the calligraphy for indicating the category that an individual word belongs to, such as that [symbol] (maple) belongs to the tree category, same principle applies to a fish, an insect, an action involving the use of a hand, etc. This specific part provides a pictorial effect of its group association; it does not contribute to a phonetic value, which is provided by the remaining portion in the word's calligraphy. All Chinese Dictionaries arrange words according to this principle. This basic concept of combination of pictorial specific symbol for Chinese written word for group classification and a phonetic part written in English alphabets forms the foundation of this invention.

“Transliterate” is defined in Webster's Dictionary as: “to write or spell in the characters of another alphabet that represent the same sound or sounds”.

A Chinese written word (or Kanji, [symbol] [symbol] , in Japanese wording) has been loosely called by Western linguists as a Chinese character. (Reference 3, an authoritative writing on Chinese language study for teaching conversational Chinese to non-Chinese speaking people, it had quoted “600 characters introduced in Read Chinese 1 and 2” as the most fundamental Chinese written words. Its phonetic presentation is in Yale Romanization of Chinese characters). There exists now about a total of 45,000 independent Chinese characters (or written words), that are distinctive visually, but phonetically much of these written words sound the same.

Japanese and Korean written words are also routinely called by Western linguists as Japanese and Korean characters, Ref. 4, which has been and still is the authoritative writing of its kind for thirty years. This dictionary selected 5,000 basic Japanese characters and a total of accompanied derivative phrases of 70,000 entries. Many of these Japanese characters are identical Chinese written words that they are pronounced usually in different phonetic ways from original Chinese spellings. (Reference 4: The Modern Reader's “Japanese-English Character Dictionary”, by A. N. Nelson, Ph.D., Second Ed., Charles E. Tuttle Co. Publishers of Rutland Vermont, Tokyo, Japan, 1969.)

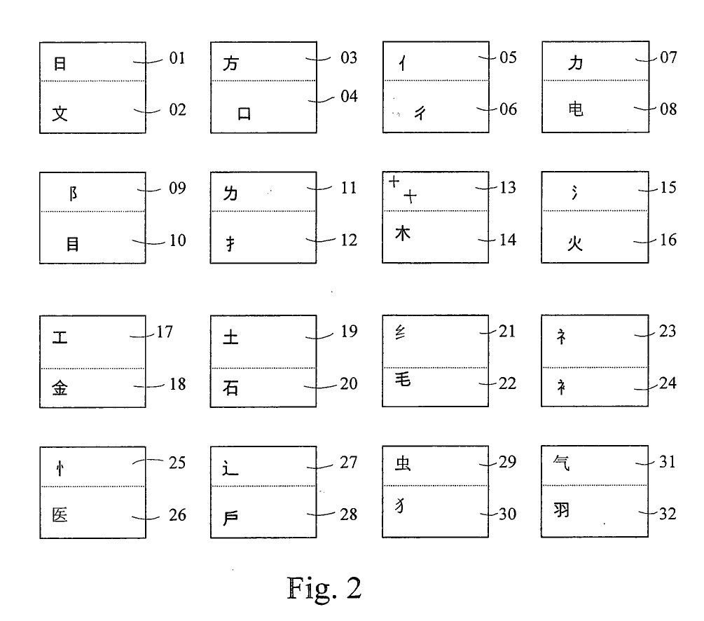

The “specific Chinese character keys” used in this invention as depicted in FIG. 2 of this present invention are symbols for classification of actual Chinese words, these symbols are all silent in the actual inputting Chinese written words whose sound values are written in English alphabets following this symbols. All Chinese students are familiar with these classification symbols in their traditional calligraphically writings. The pictorial “specific lettering symbols” used in this invention as listed in FIG. 2 are different, they are used for a Chinese written word's meaning classification, and they are silent in spelling. Here “character” means an individual Chinese written word with single syllable sound, and are distinctively different from the pictorial “specific lettering symbols” used in this invention as listed in FIG. 2.

“Transliterate” is defined in Webster's Dictionary as: “to write or spell in the characters of another alphabet that represent the same sound or sounds”.

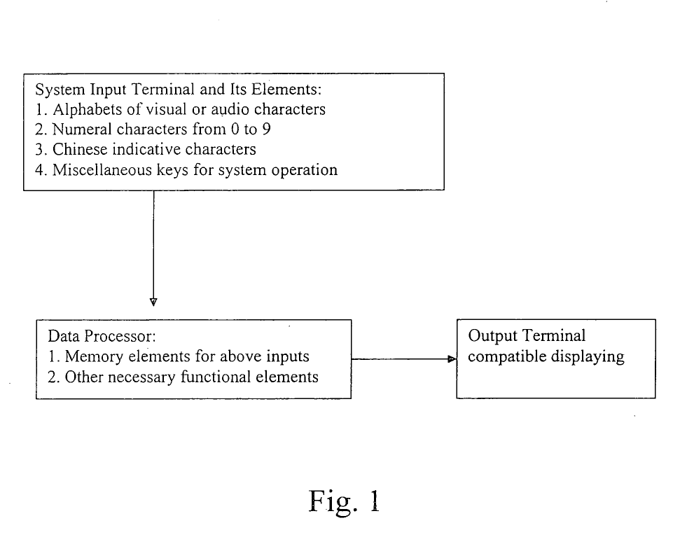

FIG. 1 is a schematic drawing indicating the functional relationship between the terminal devices and a data processor. The input terminal device embodies the following elements:

1. Alphabetical letter keys of the English language.

2. The numerical keys from 0 to 9.

3. Other miscellaneous symbolic and functional keys.

4. The specific Chinese character keys which are mostly used for indicative purposes to differentiate the meaning of words of similar phonetic values. A few of these are used for phonetic purpose as well, since these distinctive sounds cannot be obtained by any combination of English alphabets. Specifically:

4-01 [symbol] =a symbol indicating light, time

4-02 [symbol] =a symbol indicating culture, civilization

4-03 [symbol] =a symbol indicating direction, a state of being, a process

4-04 [symbol] =a symbol indicating food, speak, actions associated with mouth

4-05 [symbol] =a symbol indicating people

4-06 [symbol] =a symbol indicating action, movement

4-07 [symbol] =a symbol indicating the use of force

4-08 [symbol] =a symbol indicating phenomenon associated with electricity

4-09 [symbol] =a symbol indicating hearing, sound

4-10 [symbol] =a symbol indicating viewing with eyes

4-11 [symbol] =a symbol indicating body parts

4-12 [symbol] =a symbol indicating actions associated with hand

4-13 [symbol] =a symbol indicating grass, vines, etc.

4-14 [symbol] =a symbol indicating wood, wood products

4-15 [symbol] =a symbol indicating water, liquid

4-16 [symbol] =a symbol indicating fire, heat

4-17 [symbol] =a symbol indicating labor, industrial products

4-18 [symbol] =a symbol indicating metal, metal products

4-19 [symbol] =a symbol indicating soil, dirt, place

4-20 [symbol] =a symbol indicating rock, mountain

4-21 [symbol] =a symbol indicating fabrics, organization

4-22 [symbol] =a symbol indicating wool, hair

4-23 [symbol] =a symbol indicating worship, respect

4-24 [symbol] =a symbol indicating covering

4-25 [symbol] =a symbol indicating mental activities

4-26 [symbol] =a symbol indicating medical, health

4-27 [symbol] =a symbol indicating transportation, destination, etc

4-28 [symbol] =a symbol indicating building, rooms

4-29 [symbol] =a symbol indicating insects and smaller crawling animals

4-30 [symbol] =a symbol indicating four feet land animals

4-31 [symbol] =a symbol indicating air gas, aerial activities

4-32 [symbol] =a symbol indicating feather, flying activities

4-33 [symbol] =a symbol indicating measurements

The symbol “#” is a Chinese character that had been used over 3,000 years, it later was used in other world languages. It means well (water well, gas well, etc.) in Chinese. It is pronounced as “jen” in Chinese, a sound that is coincident with a fundamental unit in Chinese weight measurement is used here. Additionally, the conventional symbol “$” (meaning dollar sign) is used in this invention also as an indicative symbol for articles or actions associated with monetary value when this “$-symbol” is used as an integral part of a Latinized Chinese-style word.

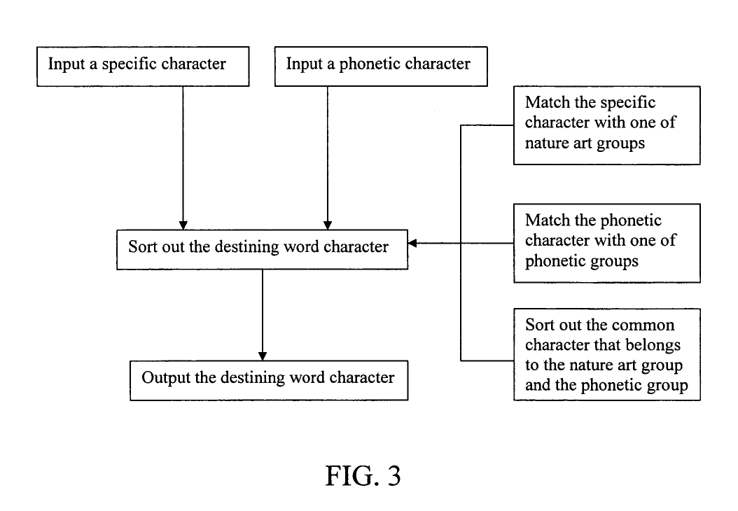

Referring to FIG. 3 of the drawings, a process for inputting word character according to a preferred embodiment of the present invention is illustrated, wherein the process comprises the following steps.

(1) Input a specific character denoting a nature art of destining word character; wherein the specific character is inputted by a combination of numerical keys from 0 to 9 or by a combination of symbolic keys.

(2) Input a phonetic character denoting a phoneme of the destining word character; wherein the phonetic character is inputted by a combination of alphabetical letter keys from A to Z and based on Mandarin phonetic system.

(3) Sort out the destining word character in responsive to the specific character and the phonetic character.

(4) Output the destining word character.

According to the preferred embodiment, the destining word character is a Chinese-styled language character.

According to the preferred embodiment, the user is able to firstly input one of the specific character in the step (1) and the phonetic character in the step (2). As it is mentioned above, the specific character input by the user denotes a nature art of destining word character. For example, when the user wants to input a Chinese word “ [symbol] ”, which means “steel” in English, he or she may simply define the nature art of “steel”. It is known that steel is a metal or a metal product such that the user is able to enter the symbol of “ [symbol] ” to denote the nature art of “steel”. In other words, by defining the nature art of the word character, the unnecessary word characters, which do not belong to that particular nature art group, will be eliminated.

The phonetic character is inputted based on Mandarin phonetic system according to the preferred embodiment. However, other phonetic systems, such as Cantonese phonetic system, can be used to define the phoneme of the destining word character. For example, when the user wants to input a Chinese word “ [symbol] ”, which means “steel” in English, he or she may simply the word “GON” which has a phoneme similar to the Chinese word “ [symbol] ”. In other words, the unnecessary word characters, do not belong to that particular phonetic group, will be eliminated. It is worth to mention that the Chinese pinyin and general pinyin instillation are both adapted for the phoneme of the destining word system.

Therefore, when the word character matches with both the specific character and the phonetic character as the common character, the word character is determined as the destining word character. For example, when the user input the nature art of “steel” as the specific character and the “GON” as the phonetic character, the common character of “ [symbol] ” is sorted out only.

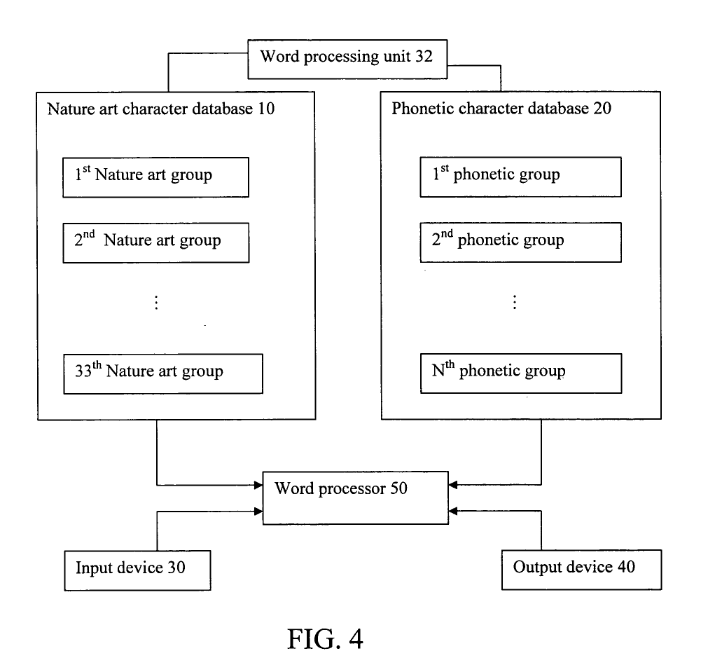

Referring to FIG. 4 of the drawing, the present invention also provides word a processing system which comprises a nature art character database 10, a phonetic character database 20, an input device 30, an output device 40, and the word processor 50.

The nature art character database 10 contains a plurality of nature art groups, wherein each of the nature art groups contains a plurality of word characters classified with a common nature art. Accordingly, the nature art groups stored in the nature art character database 10 is shown in FIG. 2.

The phonetic character database 20 contains a plurality of phonetic groups, wherein each of the phonetic groups contains the word characters classified with a common phoneme.

The word processor 50 sorts out a common character from the nature art character database 10 and the phonetic character database 20 in responsive to the specific character and the phonetic character. It is worth to mention that each of the word characters should be sorted by one or more natural arts grouped in one or more natural art groups respectively and one or more phonemes grouped in one or more phonetic groups such that the word processor 50 is adapted to sort out the common character from the natural art group and the phonetic group.

According to the preferred embodiment, the process of the present invention, in the step (3), further comprises the following steps.

(3.1) Match the specific character with one of nature art groups stored in the nature art character database 10, wherein each of the nature art groups contains a plurality of word characters classified with a common nature art.

(3.2) Match the phonetic character with one of phonetic groups stored in the phonetic character database 20, wherein each of the phonetic groups contains a plurality of word characters classified with a common phoneme.

(3.3) Sort out the common character that belongs to the nature art group and the phonetic group as the destining word character, such that the common character falls not only in the nature art group in responsive to the specific character but also in the phonetic group in responsive to the phonetic character.

As it is mentioned above, when the user firstly input the specific character, the system of the present invention will determine the corresponding nature art group within the nature art character database 10 and the word characters belonging to that nature art group. Other word characters which belong to other nature art groups will be eliminated. Then, after the phonetic character is inputted, the system will sort out the word character within that nature art group in responsive to the common phoneme of the phonetic character, so as to speed up the entire process of determining the destining word character.

Alternatively, when the user firstly input the phonetic character, the system of the present invention will determine the corresponding phonetic group within the phonetic character database 20 and the word characters belonging to that phonetic group. Other word characters which belong to other phonetic groups will be eliminated. Then, after the specific character is inputted, the system will sort out the word character within that phonetic group in responsive to the nature art of the specific character, so as to speed up the entire process of determining the destining word character.

Likewise, the system of the present invention can determine the destining word character after the inputs of the specific character and the phonetic character in an unspecifically order manner. In other words, the system of the present invention will sort out the common character that belongs to the nature art group and the phonetic group.

The input device 30 inputs the specific character denoting a nature art of destining word character and the phonetic character denoting a phoneme of the destining word character, wherein the destining word character is a Chinese-style language character and the phonetic character is inputted based on Mandarin phonetic system.

According to the preferred embodiment, the input device 30 comprises a key panel 31. The key panel 31 comprises a plurality of function keys 311 and a plurality of alphabetical letter keys 312, from A to Z, wherein the function keys 311 are used to input a specific character by a combination of the function keys 311, wherein the alphabetical letter keys 312 are used to input a phonetic character by a combination of the alphabetical letter keys 312.

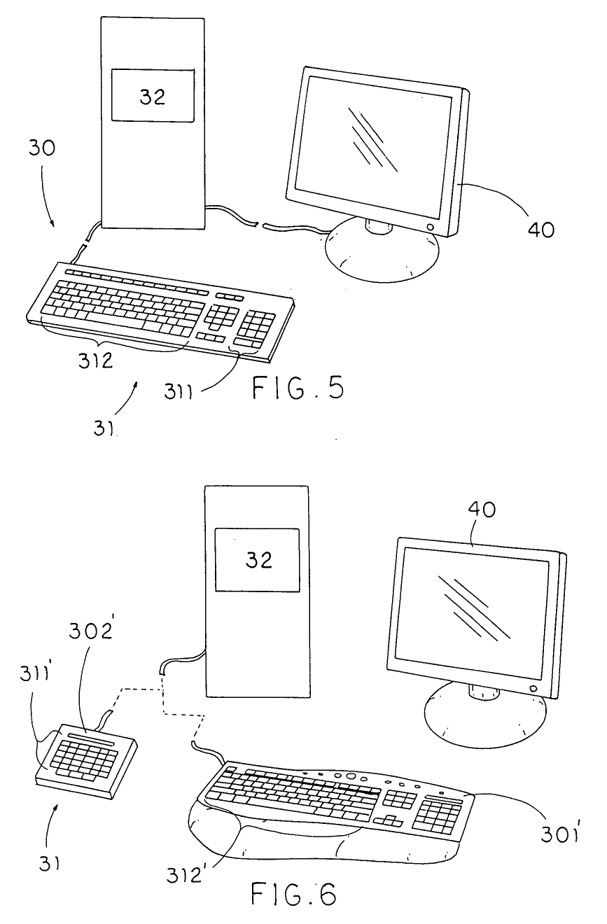

As shown in FIG. 5, the key panel 31 of the input device 30 can be an existing keyboard having a first key section defining the alphabetical letter keys 312 therewithin such that the user is able to input the phonetic character by a combination of the alphabetical letter keys 312 based on the Mandarin phonetic system. For example, when the user wants to input a Chinese word “ [symbol] ”, he or she may simply enter “GON” as the phonetic character via the alphabetical letter keys 312. Accordingly, the system will determine the phonetic group of the Chinese word “ [symbol] ” and other Chinese words having the similar phoneme such as [symbol] , [symbol] , [symbol] and [symbol] .

The specific character is inputted by a combination of numerical keys from 0 to 9. In other words, the existing keyboard has a second key section defining the numerical keys 311 therewithin such that the user is able to input the specific character by a combination of the numerical keys 311. For example, when the user wants to input a Chinese word “ [symbol] ”, he or she may simply enter “18” as the specific character via the numerical keys 311, wherein the “18” is assigned to denote the nature art of the Chinese word “ [symbol] ”.

Another example for illustrating the input of the present invention is shown as follows. When the user wants to input the Chinese word “ [symbol] ” which means wood, he or she may determine the nature art and the phoneme of that Chinese word. The pronounce of the Chinese word “ [symbol] ” is “LIN”. Accordingly, the system will determine the phonetic group of the Chinese word “ [symbol] ” and other Chinese words having the similar phoneme such as [symbol] , [symbol] , [symbol] , and [symbol] , also the nature art of the Chinese word “ [symbol] ” is wood. Therefore, the user is able to simply input the numerical keys of “14” as the specific character to refine the natural art group and input “LIN” as the phonetic character to refine the phonetic group. Therefore, the common character matching with the natural art group and the phonetic group is sorted out to determine the destining word character as the Chinese word “ [symbol] ”.

Alternatively, the key panel 31′ comprises a first keyboard 301′ as the existing keyboard defining the alphabetical letter keys 312′ thereat and a second keyboard 302′ externally and operatively connected to the first individual keyboard, wherein the function keys 311′ are symbolic keys provided at the second keyboard 302′. In other words, the second keyboard 302′ can be an external keyboard for connecting to the exiting keyboard to input the phonetic character.

Accordingly, the nature art character database 10 and the phonetic character database 20 are combined to form a word processing unit 32 to operatively link to the key panel 31. The nature art character database 10 and the phonetic character database 20 are formed as a software program that when the word processing unit 32 is installed into the computer as a language input interface thereof, the nature art character database 10 and the phonetic character database 20 are extracted in the computer.

According to the preferred embodiment, the output device 40 is arranged for outputting the common character as the destining word character. The output device 40 comprises a display screen displaying the destining word character thereon.

It is worth to mention that the above examples illustrate the process of inputting the Chinese word. However, it would be obvious that other style languages can be inputted through the process. For example, the present invention can be used for inputting Spanish-style language by refining the Spanish word character through the natural art and the phoneme thereof. In addition, the user, who is not a Chinese native speaker and can only pronounce the Chinese word, is able to use the present invention for inputting Chinese word because the user is able to refine the natural art and the phoneme of the Chinese word easily.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A process for inputting word character, comprising the step of:
(a) inputting a specific character denoting a nature art of destining word character;
(b) inputting a phonetic character denoting a phoneme of said destining word character;
(c) sorting out said destining word character in responsive to said specific character and said phonetic character; and
(d) outputting said destining word character.

2. The process, as recited in claim 1, wherein the step (c) comprises the steps of:
(c.1) matching said specific character with one of nature art groups stored in a nature art character database, wherein each of said nature art groups contains a plurality of word characters classified with a common nature art;
(c.2) matching said phonetic character with one of phonetic groups stored in a phonetic character database, wherein each of said phonetic groups contains a plurality of word characters classified with a common phoneme; and
(c.3) sorting out a common character that belongs to said nature art group and said phonetic group as said destining word character, such that said common character falls not only in said nature art group in responsive to said specific character but also in said phonetic group in responsive to said phonetic character.

3. The process, as recited in claim 1, wherein said destining word character is a Chinese-styled language character.

4. The process, as recited in claim 2, wherein said destining word character is a Chinese-styled language character.

5. The process as recited in claim 4 wherein, in the step (a), said specific character is inputted by a combination of numerical keys from 0 to 9.

6. The process as recited in claim 4 wherein, in the step (a), said specific character is inputted by a combination of symbolic keys.

7. The process as recited in claim 4 wherein, in the step (b), said phonetic character is inputted by a combination of alphabetical letter keys from A to Z.

8. The process, as recited in claim 7, wherein said phonetic character is lo inputted based on Mandarin phonetic system.

9. A word processing system, comprising:
a nature art character database containing a plurality of nature art groups, wherein each of said nature art groups contains a plurality of word characters classified with a common nature art;
a phonetic character database containing a plurality of phonetic groups, wherein each of said phonetic groups contains said word characters classified with a common phoneme;
an input device inputting a specific character denoting a nature art of destining word character and a phonetic character denoting a phoneme of said destining word character;
a word processor sorting out a common character from said nature art character database and said phonetic character database in responsive to said specific character and said phonetic character; and
an output device outputting said common character as said destining word character.

10. The word character inputting system, as recited in claim 9, wherein said destining word character is a Chinese-styled language character.

11. The word character inputting system, as recited in claim 10, wherein said input device comprises a plurality of numerical keys from 0 to 9 to input said specific character by a combination of said numerical keys.

12. The word character inputting system, as recited in claim 10, wherein said input device comprises a plurality of symbolic keys to input said specific character by a combination of said symbolic keys.

13. The word character inputting system, as recited in claim 10, wherein said input device comprises a plurality of alphabetical letter keys from A to Z to input said phonetic character by a combination of said alphabetical letter keys.

14. The word character inputting system, as recited in claim 13, wherein said phonetic character is inputted based on Mandarin phonetic system.

15. The word character inputting system, as recited in claim 10, wherein said output device comprises a display screen displaying said destining word character thereon.

16. An input device for inputting word character, comprising:
a key panel comprising a plurality of function keys and a plurality of alphabetical letter keys from A to Z, wherein said function keys are used to input a specific character by a combination of said function keys, wherein said alphabetical letter keys are used to input a phonetic character by a combination of said alphabetical letter keys; and
a word processing unit, comprising:
a nature art character database containing a plurality of nature art groups, wherein each of said nature art groups contains a plurality of word characters classified with a common nature art;
a phonetic character database containing a plurality of phonetic groups, wherein each of said phonetic groups contains said word characters classified with a common phoneme; and
a word processor sorting out a common character from said nature art character database and said phonetic character database in responsive to said specific character and said phonetic character, wherein said common character is a destining word character.

17. The input device, as recited in claim 16, wherein said destining word character is a Chinese-styled language character.

18. The input device, as recited in claim 17, wherein said phonetic character is inputted based on Mandarin phonetic system.

19. The input device, as recited in claim 18, wherein said key panel has a first key section defining said alphabetical letter keys therewithin and a second key section defining said function keys therewithin, wherein said function keys are numerical keys from 0 to 9.

20. The input device, as recited in claim 18, wherein said key panel comprises a first keyboard defining said alphabetical letter keys thereat and a second keyboard externally and operatively connected to said first individual keyboard, wherein said function keys are symbolic keys provided at said second keyboard.
